(19) United States
(12) Patent Application Publication
(10) Pub. No.: US 2016/0225280 A1
(43) Pub. Date: Aug. 4, 2016

(54) METHOD FOR TREATING POST-TRAUMATIC STRESS DISORDER

(71) Applicant: Frank J. Bourke, Corning, NY (US)

(72) Inventor: Frank J. Bourke, Corning, NY (US)

(21) Appl. No.: 15/016,627

(22) Filed: Feb. 5, 2016

Related U.S. Application Data
(63) Continuation-in-part of application No. 13/770,556, filed on Feb. 19, 2013, now abandoned.
(60) Provisional application No. 61/600,174, filed on Feb. 17, 2012.

(51) Int. Cl. G09B 19/00

(52) U.S. Cl. CPC G09B 19/00

(57) ABSTRACT

The subject matter disclosed in this specification pertains to a method for treating post-traumatic stress disorder. An individual is asked about a problem state and feedback is observed. When the individual is identified entering the problem state, the state is broken. The individual is requested to engage in a first visualization of an unrelated event while in a dissociated state, a second visualization of the traumatic event while in a dissociated state and third visualization of the traumatic event while in an associated state but wherein the event is played in reverse.

### CROSS-REFERENCE TO RELATED APPLICATIONS

This application is a continuation-in-part of U.S. patent application Ser. No. 13/770,556 (filed Feb. 19, 2013) which claims priority to U.S. provisional Patent application Ser. No. 61/600,174 (filed Feb. 17, 2012) the entirety of which are incorporated herein by reference.

### BACKGROUND OF THE INVENTION

The subject matter disclosed herein relates to methods of treating post-traumatic stress disorder (PTSD) and method for recording the progress of such treatments overtime.

Post-traumatic stress disorder (PTSD) is an anxiety-type disorder that can occur after an individual has experienced or seen a traumatic event, often that involved the threat of injury or death. PTSD alters the body's response to stress and otherwise has pronounced effects on the psychological and physical health of the individual. Current treatments often involve having the individual “relive” the traumatic event in an effort to desensitize them. Unfortunately, these treatments are not entirely satisfactory. Alternative treatment methods are therefore desirable.

The discussion above is merely provided for general background information and is not intended to be used as an aid in determining the scope of the claimed subject matter.

### BRIEF DESCRIPTION OF THE INVENTION

The subject matter disclosed in this specification pertains to a method for treating post-traumatic stress disorder. An individual is asked about a problem state and feedback is observed. When the individual is identified entering the problem state, the state is broken. The individual is requested to engage in a first visualization of an unrelated event while in a dissociated state, a second visualization of the traumatic event while in a dissociated state and third visualization of the traumatic event while in an associated state but wherein the event is played in reverse.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a flow diagram of a method for treating post-traumatic stress disorder; and

FIG. 2 is a flow diagram depicting method for treating post-traumatic stress disorder.

### DETAILED DESCRIPTION OF THE INVENTION

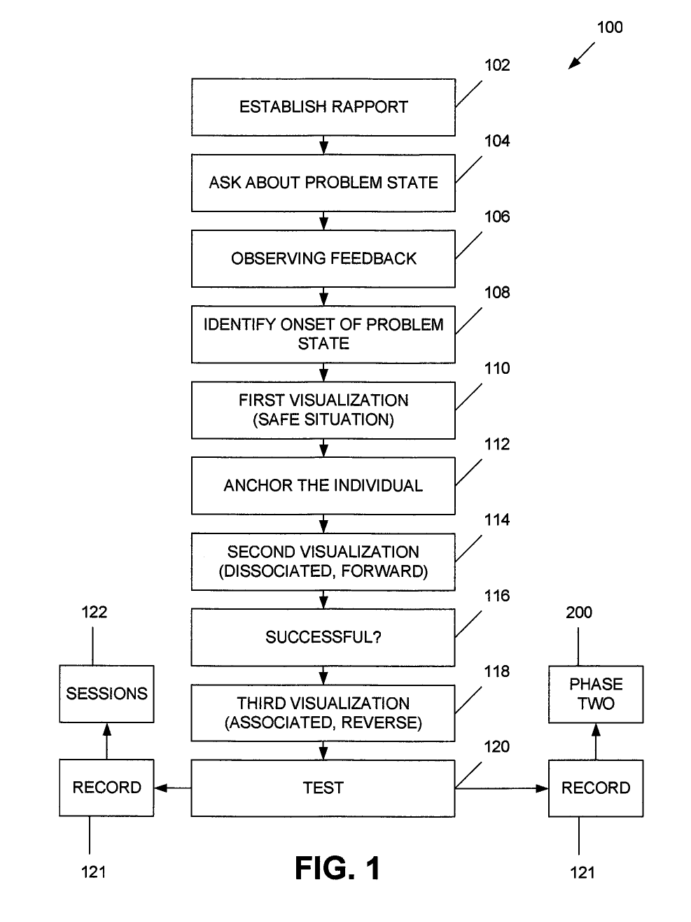

FIG. 1 is a flow diagram of a method 100 for treating post-traumatic stress disorder. Method 100 is phase one of a treatment protocol. The method 100 comprises step 102 wherein a rapport is established with an individual who is suffering from post-traumatic stress disorder (PTSD). During step 102, a therapist may explain to the individual that the method is ordinarily comfortable but may have very short periods of moderate discomfort. The therapist may also ask about previous attempted therapies and/or explain how method 100 is very different from conventional PTSD therapies. For example, the therapist may explain that the method 100 does not involve re-living traumatic events, catharsis or a release of feelings. In some embodiments of the method, the therapist may also the individual to establish a kinesthetic anchor through touch. For example, the therapist may place his or her hand on the forearm of the individual and ask if such touching is permissible. If permission is not granted, the therapist may further indicate that such kinesthetic anchor is not essential.

In step 104, the therapist asks about a problem state that is believed to be responsible for the PTSD. Exemplary questions include: “What is your problem and how does it present itself?” “What is the traumatic event or events that caused it?” “What does the problem trouble you most?” “What are the symptoms associated with the problem?” “Where are any unpleasant feelings located in the body?” “What is it like when you experience these symptoms?”

Step 106 is performed simultaneously with step 104. In step 106 the therapist observes feedback from the individual. Specifically, the therapist will attend to the physiological and paralinguistic elements that reflect heighted arousal and the elicitation of the problem state. The therapist may be particularity watchful for observed elements indicative of fear or trauma. Changes in breathing, heart rate, skin tone and color, vocal pitch, speech rate, muscular tension, tremors and changes in posture may be observed by the therapist.

In step 108, the therapist identifies the individual entering the problem state based on the observables from step 106. The therapist may also be specifically observing what questions (step 104) specifically triggered the onset of the problem state. The therapist may also note whether the individual was focused inwardly or outwardly as problem state was entered. As soon as the therapist identifies the individual entering the problem state, the problem state is immediately interrupted. For example, the therapist may move into the client's field of vision and change the topic by, for example, discussing weather, favorite foods or any other innocuous topic that is unrelated to the problem state.

In step 110 the therapist requests the individual engage in a first visualization while they are in a dissociative state. In the first visualization the individual is requested to remain in a dissociated state with respect to the first visualization. The first visualization is of a neutral or otherwise safe event that is unrelated to the problem state. For example, the individual may be asked to engage in a first visualization that includes the individual sitting in a movie theater watching a still image of the individual performing a neutral activity in a safe context. Because the individual is an observer of the activity, rather than a participant, the individual is said to be in a dissociative state. Any suitable dissociative technique may be used including imagining a physical dissociation by floating away to a project booth behind a transparent barrier, floating away from the body and imagining that the individual is standing behind his or her body holding their own shoulders and monitoring their own embodied state or distorting the image sufficiently that no association to the image is possible.

In step 112 the therapist anchors the individual during the first visualization (step 110). The anchor may be a physical anchor (e.g. a few fingers or a hand placed on the individual's forearm) or a verbal anchor (e.g. repeating the word “Good” said slowly in a distinctive tone). In one embodiment, the anchor is distinctive and repeatable such that, over time, the individual is conditioned to respond to the stimulus with a feeling of being anchored in the same room with the therapist. The anchor provides a psychological anchoring point to keep the individual mentally present in the room with the therapist and prevent the visualization from overtaking the individual.

In step 114, after the individual has experienced the first visualization of a neutral activity, the individual is requested to engage in a second visualization. For example, the second visualization may comprise the individual in a movie theater viewing a pre-traumatic event still image of himself or herself. As the individual focuses on this still image, the therapist provides supplemental instructions to request the individual envision a movie of the traumatic event in a dissociated state, including progressing through the traumatic event to the point where the individual survived and thereafter hold this post-traumatic event still image in their mind. After receiving the supplemental instructions, the individual releases the pre-traumatic even still image, proceeds to visualize the traumatic event movie and finally holds the post-traumatic event still image in their mind. In one embodiment, the traumatic even movie is visualized in black and white to assist the individual in recognizing that the second visualization is not real. In one embodiment the therapist anchors the individual during the second visualization.

In step 116, an assessment is made to determine if the second visualization was successful. If the individual cannot complete the second visualization without significant distress, the process is repeated and a new anchor is recreated. Additionally, if the individual claims the second visualization was successful but the therapist is uncertain if the problem state occurred during the visualization (step 114) then the method 100 is repeated beginning with step 110. The therapist should be watchful for signs of mild distress. In one embodiment, the individual is requested to only engage in the second visualization by picturing a subsection of the movie. For example, only the top half, only the bottom half, only even or odd numbered seconds of the movie, etc. If the individual displays signs of acute distress, the second visualization may be interrupted. For example, the therapist may move into the client's field of vision and change the topic by, for example, discussing weather, favorite foods or any other innocuous topic that is unrelated to the problem state.

If the individual indicates the second visualization of the traumatic event can be performed without the problem state occurring and the therapist concurs that no observables of the problem state were evident, then the anchor may be removed and step 118 is executed.

In step 118, the individual envisions a third visualization. The third visualization comprises the post-traumatic event still image from the second visualization. The individual then envisions himself or herself as an active participant in the traumatic event (i.e. in an associated state) but wherein the traumatic event plays in reverse starting from the moment of the post-traumatic event still image. In one embodiment, the reverse vision is run at very high speeds. In one such embodiment, the reverse vision is pictured in color. In one embodiment, step 118 is performed only one time. In another embodiment, step 118 is performed several times.

In step 120, which is performed after step 118, the therapist attempts to trigger the problem state using knowledge gained during steps 104 and 106. The specific questions that are known to trigger the problem state are asked. If the problem state can be triggered then further sessions may be necessary (step 122). If the problem state could not be triggered then phase two (method 200) may be performed.

In some embodiments, step 121 is executed after step 120 wherein the results of the method are recorded. For example, the therapist may record observations that triggered the onset of the problem state. The therapist may record whether or not the problem state could be triggered in step 120 or the degree to which the problem state was manifested. Such records of therapy are useful to monitor the progress of the individual over a prolonged period of time. For example, the therapist may record these observations in a hand-written notebook or in an electronic device, such as a computer.

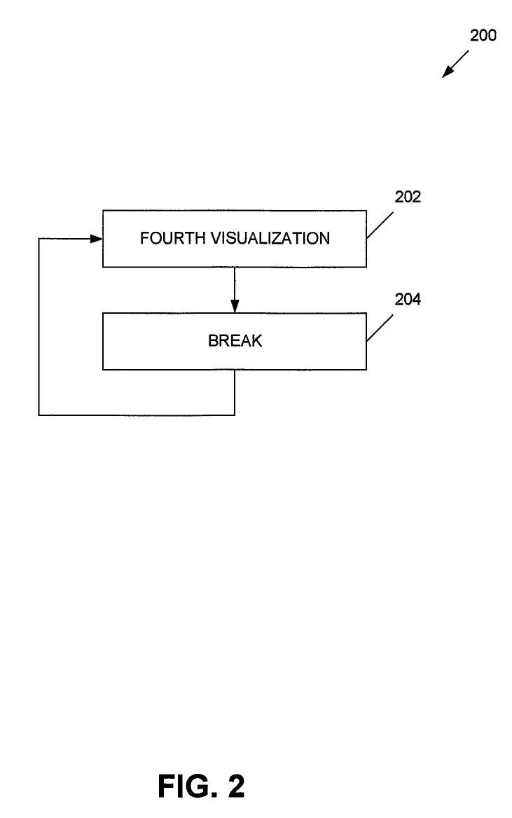

FIG. 2 is a flow diagram depicting method 200 for treating post-traumatic stress disorder. Method 200 is phase two of the treatment protocol. In step 202 of method 200, the therapist requests the individual engage in a fourth visualization that includes the traumatic event (in an associated state) but where the traumatic event has been altered such that the individual was not injured. For example, a third party may intervene or the individual may make a different decision. The fourth visualization, in one embodiments, recreates the traumatic event as nearly as possible except in that the individual is not injured.

In step 204, after one iteration of the fourth visualization, the visualization is interrupted. For example, the therapist may move into the client's field of vision and change the topic by, for example, discussing weather, favorite foods or any other innocuous topic that is unrelated to the problem state. The steps 202 and 204 may be repeated, for example, eight to ten times.

In a post-phase two assessment, the individual may be asked how they experienced the procedure. The therapist observes the non-verbal behavior of the individual. The individual should display a resourceful and untroubled physiology free of the indicia of trauma elicited at the evocation stage. The individual should be more congruent and balanced than at the end of the phase-one treatment.

### Design & Procedures:

A pre-pilot study hypothesizing significant changes in the pre-and post-psychological measures and blood biomarkers of PTSD especially in the psychological scales reflecting problematic nightmares, flashbacks and related anxiety. Changes in the proportion if RNA blood biomarkers in the pre-post blood tests were observed.

It is hypothesized that genes encoding proteins regulating immune system function, genes encoding glutathione-S-transferase proteins, and genes encoding stress hormones and receptors will all be high-likelihood biomarkers of response to PTSD treatment

The bloodmarker will not be the main diagnostic for clinical success. However if the gene marker hypothesis is not rejected, this will pave the way for the creation of an unambiguous biomarker for PTSD and its resolution.

Inclusion Criteria for the test were:

1. Adult males, 18-65 years of age.

2. Subjects capable of giving informed consent and willing to participate in the study.

3. Diagnosed with PTSD by scores on the PSSI and the SRS-PTSD and;

a. must have had traumatic experiences threatening death or injury to themselves or others.

b. must be expressing traumatic symptoms of flashbacks or panic reactions to stimulus related to the traumatic event.

Exclusion Criteria:

1. Axis I disorders of psychosis or dementia

2. Axis II disorders of severe mental retardation and autism, severe personality disorders and severe psychoactive substance abuse disorders

3. Current Psychosocial Stressor Rating of six.

4. Global Assessment of Functioning of 30 or below.

5. Inability to complete prescreening.

The pre and post measures of the small sample of PTSD diagnosed veterans (30) were compared using standard statistical analysis to ascertain the presence of statistically significant difference in pre and post measures at the 95% confidence level. The life threatening experience does not have to be related to war experience. A reduction in scores for intrusive and hypervigilant symptoms is hypothesized to approach 80% post administration of the RTM protocol. If this hypothesis is supported, the RTM will have been delivered successful treatment for the intrusive and hypervigilant symptoms of PTSD in less than four hours, on average.

Given that the most effective PTSD treatment, Cognitive Behavior Therapy, takes at least three months and meta-analyses of those studies finds a 40% to 50% removal of the symptoms diagnostic for PTSD post administration, it was hypothesized that the results of the present study warranted interest in a larger pilot study (150 veterans in a wait-list design). It is also intended to provide reviewers for the pilot study at the Alternative Medical Division of NIH and the Veterans Administrations Research Division the detailed sample protocols they requested to be attached to the Pilot study resubmission.

5. Selection of Subjects:

Subjects will be pre-screened, after successful completion of the Consent and Information form, for baseline measures., using the PTSD Symptom Scale Interview (PSSI) and the Self rating Scale for PTSD (SRS-PTSD) prior to submitting a blood sample and beginning treatment. Subjects who express suicidal ideation or intent at any time during the study will be immediately referred to the licensed psychologist in the study team, determine the severity of the threat and where necessary develop a safety plan and if appropriate, treatment referrals. Any subjects presenting, in the prescreening or baseline phase of the study, as a serious threat to themselves or others will be excluded from the study, and clinically referred for treatment appropriate to their level of severity. Professional staff are licensed to monitor and respond effectively to maintain subject safety in all research and clinical situations such as those reflected in this study. Study research staff have been trained to recognize and deal with minor safety problems and have immediate access, on premises, to professional staff for help during study procedures if any questionable safety developments occur. Professional staff will always be present during study procedures and available during the study through the 24 hour telephone hotline provided to the subjects.

It is assumed that a good number of the subjects will be enrolled in treatment programs as well as taking prescription medications. These will be noted in the baseline data. Their PTSD symptoms will have typically been resistant to those treatments for two to five years and will have displayed very gradual erosion. Clinical applications of the RTM protocol have demonstrated complete cessation of PTSD symptoms in over 85% of the subjects in less than four hours of treatment. If this finding is duplicated in this pre-pilot study it will warrant further more vigorous investigation with control for confounding variables such as parallel therapy and medication treatment.

A Mini-International Neuropsychiatric Interview will be performed, to rule out subjects with Axis I and Axis II disorders. Any subjects not scoring sufficiently high on the PSSI or SRS-PTSD to warrant a PTSD diagnosis will be excluded from the study. For the SRS this requires a score of one or more on the re-experiencing symptom group; a score of three or more on the avoidance group; and a score of two or more on a hyper-arousal group. For the PSSI, a PTSD diagnosis is determined by counting the following number of symptoms endorsed per symptom cluster; re-experiencing 1; avoidance 3; and arousal 2.

Additionally, any subject not demonstrating a phobic, instantaneous conditioned response to traumatic ideation will be told their particular symptoms do not lend themselves to this particular treatment's capabilities and excused from the study, (for this protocol to work effectively, the problem must 1. Be rooted in the personal experience of trauma threatening death or injury to one's self or others, and 2. Be expressed as an intense, suddenly arising experience of the trauma symptoms usually experienced as flashbacks or panic reactions to a stimulus related to a traumatic event”). The life threatening experience does not have to be related to war experience. They will be paid for travel expenses and given information and help finding local treatment facilities near their homes if they wish it. Any clinical problems arising from this exchange or any subsequent problems will be dealt with by the Licensed Clinical Psychologist administering the pre-screening and treatment protocol.

After initial intake, subjects will be instructed to complete the PCL-M either on line or with a clinician.

After completion of the testing session, subjects will be scheduled for the first treatment protocol administration. All administrations of the RTM protocol will be video-taped in their entirety. Subjects' treatment will be ended when either four treatment sessions have elapsed or treatment success is determined based on physiological indicia. This is accomplished by the practitioner making every effort to evoke the trauma associated problem state and not being able to do so. This is done using the same questions and probes used to access the problem state with special attention to those questions that were associated with a clear physiological reaction. If there is no reaction, the intervention is presumed to have worked and the treatment sessions are terminated. The post treatment assessment will consist of the administration of the identical test instruments in the pretreatment assessment administered within two weeks of the last treatment session. Additionally, all subjects will be requested to complete a SRS-PTSD three months after the last subject has completed the post assessment.

No two interventions, testing or treatment, will be conducted on the same day. No more than two weeks will expire between all interventions. All treatment protocol interventions will have at least two days separation between applications.

1. Visit number one (3 to 4 hours): Information and Consent, Prescreening and Baseline (PSSI, SRS, MINI, and PCL-M), blood draw.

2. Visit number two (1 to 2 hours): Application of the RTM treatment protocol.

3. Visit number three (1 to 2 hours): Re-application of the RTM treatment protocol and test for presence of traumatic response. (if no traumatic response go to last visit, Post Testing Battery).

(4). Visit number four (1 to 2 hours): Re-application of the RTM treatment protocol and test for presence of traumatic response. (if no traumatic response go to last visit, Post Testing Battery).

(5). Visit number five (1 to 2 hours): Re-application of the RTM treatment protocol and test for presence of traumatic response. (if no traumatic response go to last visit, Post Testing Battery).

6. Visit number six (3 to 4 hours): Re-submission of the PCL-M. Upon study completion subjects will be asked if they wish any help finding clinical help or local treatment facilities near their homes and provided with such, if they wish it.

### Protocol Outline

### Phase One

### 1. Prescreening.

The client's difficulties are essentially a phobic, instantaneous conditioned response to a stimulus related to a traumatic event.

It includes flashbacks and other immediate panic responses to reminders of the traumatic event

It is not centered in the client's responses to the meanings of the event in the client's larger life and the impact of such events on the client's sense of self-worth.

The problem must 1. Be rooted in the personal experience of trauma threatening death or injury to one's self or others, and 2. Be expressed as an intense suddenly arising experience of the trauma symptoms usually experienced as flashbacks or panic reactions.

### 2. Rapport and Framing

Establish rapport and frame the intervention as

a short visualization process with that is ordinarily comfortable, but sometimes has a very short period of moderate discomfort.

Ask about any previous therapy or attempted interventions. Explain how the process is very different, from other therapies.

It does not involve “reliving” the traumatic events or “catharsis” or “release” of feelings.

Ask, “Do you have any questions or concerns before we begin? If they have any concerns about doing this process, respond congruently, and assure them that if any questions or concerns arise at any time during the process, it is fine to interrupt it and tell you what they are.

### 3. Accessing the Problem State

Decide whether to proceed with or without content.

Ask about the problem state.

What is your problem and how does it present itself?

What is the specific event or events that caused it?

When does it trouble you most?

What are the symptoms associated with it? Where are any unpleasant feelings located in the body?

What is it like when you experience these symptoms? Continue questioning and probing until client responds.

If the procedure is pursued as a content-free intervention, then the notations regarding the client's verbal behavior are somewhat mooted.

Attend to the physiological and paralinguistic elements that reflect heightened arousal and the elicitation of the problem response.

Look especially for fast onset of the physiological and paralinguistic symptoms of fear or trauma.

Note changes in breathing, heart rate, skin tone and color, vocal pitch and speech rate. Muscular tension, tremors and postural changes may also be noted as the client moves into the problem state.

As appropriate, make notes as to what the client was saying as the symptoms began, whether they were focused inwardly or outwardly, in an associated or dissociated state.

Note the specific predicates used in describing the stimulus whether visual, auditory or kinesthetic and, if mixed, in what sequence the language was used.

### 4. Break State

Interrupt the state's development as soon as possible after its identification.

Move into the client's field of vision and change the topic by discussing the weather, favorite foods or any other innocuous topic.

### 5. Dissociation and Treatment Frame

Have the client imagine that he is seated in a movie theatre.

On the screen is a still image of them performing some neutral activity in a safe context.

Have them dissociate from the image of themselves sitting in the theatre in one of the following ways:

Imagining a physical dissociation by floating away to a projection booth behind a Plexiglas barrier,

Floating away from the body and imagining that they are standing behind the body holding their own shoulders and monitoring their own embodied state

Distorting the image sufficiently that no association to the image is possible.

### 6. Dissociated Movie

Have the client observe a black and white picture of himself on the screen of the movie theatre at a time before anything ever happened.

As the client focuses on the imagined picture, he is directed to listen to the instructions all of the way through before proceeding.

Instructions:

In a few moments I'm going to ask you to watch a black and white movie of that unpleasant event, seeing yourself going through it, all the way to a point past the end of it, where you can see that you survived, and you're OK again.

When you get to the end of watching that movie, and you can see that you are OK, I want you to stop that movie as a still, black and white image. Keeping your eyes closed, you can nod your head to let me know that you have finished doing that.

“Do you understand? Great, go ahead and do that. . . .”

(Optional alternative) The client may be invited to observe the movie from the dissociated position and simultaneously to watch the dissociated watcher in the movie theatre, noting the physical signs of whatever discomfort they may be experiencing.

If the client indicates that the procedure was successful and that he is now in a comfortable place, watching a safe, disembodied image on the movie screen, proceed to the next step.

This assumes that none of the indicia of trauma noted in the accessing phase are observed in the client's demeanor, breathing, color, posture, etc.

If the practitioner is unsure of success, he can ask the client how they experienced the exercise. If there is any indication of distress, especially mild distress, have them repeat the procedure several times until they can go through it without distress.

If the client has continuing but not acute difficulty with the procedure, the procedure may be modified by instructing the client to watch only the top half of the movie, followed by only the bottom half or to watch only every third second of the movie—all the way through, followed by every second second of the movie—all the way through, followed by every first second of the movie.

If the client displays signs of acute distress.

Interrupt the procedure, distract and reorient to a safe present in rapport with the practitioner.

This may be done by reorienting them to the weather, some pleasant diversion or what they were doing immediately before entering the therapeutic situation.

If the client cannot run the imaginal exposure movie through without significant distress, the practitioner should have the client practice watching a dissociated movie of a neutral or pleasurable event that is unrelated to the trauma.

When the client has successfully completed the practice movie of a neutral event, return to the traumatic movie

When the client has successfully watched the black and white dissociated movie without distress, move on to the next step.

### 7. Associated Movie Reversal.

Begin with the safe representation of the client at the end of the dissociated black and white movie.

Have the client imagine stepping into the movie and experience the entire sequence, fully associated, in color, in reverse at very high speed (two seconds or less).

“Have you ever seen a movie run backwards? Or a videotape in fast rewind? In a moment I'm going to ask you to step into that still image on the screen, and re-experience that event backwards and in color, but with you inside that experience, so that you feel yourself moving backwards, and I want you to do this very fast. Run that movie backwards in about a second and a half, or perhaps as much as two seconds, until you get back to the beginning, before anything bad happened. Is that clear? OK, go ahead.”

Ask: what was like for you?

### 9. Test

Determine whether the procedure has had the desired effect.

Make every effort to evoke the problem state.

Use the same questions and probes used to access the problem state with special attention to those questions that were associated with a clear physiological reaction.

If there is no reaction, the intervention is presumed to have worked.

Systematically probe each sensory system for possible triggers for the problem behaviors.

When the practitioner is satisfied that she cannot evoke the PTSD response, she can continue on to the next phase.

### Phase 2

### 1. Revised Movie

The client is instructed to revisit the memory but to create a version of the experience where they were not injured; something different happened.

Perhaps someone intervenes, perhaps the client makes a different decision or makes a different turn.

The new movie should recreate the problem situation as nearly as possible but without the problem.

### 2. Break State

After one run through of the new movie, have the client break state by reorienting to the present and thinking of some neutral or pleasant activity, like what they did earlier or their favorite movie.

### 3. Rerun Revised Movie

Rerun the revised movie with a brief break after each repetition.

Both Hallbom and Dilts & Delozier recommend breaking state after each repetition.

Repeat this sequence eight to ten times.

### 4. Debrief

Ask the client how they experienced the procedure.

Observe the non-verbal behavior of the client.

The client should display a resourceful and untroubled physiology free of the indicia of trauma elicited at the evocation stage.

Their responses should be more congruent and balanced than at the end of the Phase One treatment.

(Option) The client describe the original traumatic situation while the practitioner calibrates for successful dissociation from the negative affect.

If any evidence of negative affect remains, the steps are to be repeated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for treating post-traumatic stress disorder, the method comprising steps of:
screening a group of potential clients to determine individuals with PTSD;
taking a blood sample from a selected individual;
asking the selected individual about a problem state;
observing feedback from the individual in response to the step of asking,
identifying the individual entering the problem state and immediately thereafter breaking the problem state;
requesting the individual engage in a first visualization of an event unrelated to the problem state while the individual is in a dissociated state with respect to the first visualization;
anchoring the individual during the first visualization;
requesting the individual engage in a second visualization of a traumatic event believed to be the cause of the problem state while the individual is in a dissociated state with respect to the second visualization, the second visualization comprising a pre-traumatic still image and a post-traumatic still image;
anchoring the individual during the second visualization;
removing the anchor after the second visualization is complete;
requesting the individual engage in a third visualization of the traumatic event while the individual is in an associated state with respect;
recording observations made during the first, second or third visualization for use in subsequent sessions.

2. The method as recited in claim 1, further comprising establishing a rapport with the individual.

3. The method as recited in claim 1, wherein the step of anchoring comprises providing a physical anchor by physically touching the individual.

4. The method as recited in claim 1, wherein the step of anchoring comprises providing a verbal anchor by repeating a keyboard.

5. The method as recited in claim 1, wherein the step of requesting the individual engage in the second visualization of the traumatic event is performed while the individual is visualizing a pre-traumatic event still image of the individual.

6. The method as recited in claim 1, further comprising assessing whether or not the third visualization was completed without the individual experiencing distress.

7. The method as recited in claim 6, where the individual was unable to complete the third visualization without experiencing distress, the method further comprising the step of reestablishing an anchor.

8. The method as recited in claim 6, where the individual was unable to complete the third visualization without experiencing distress, the method further comprising the step of interrupting the third visualization.

9. The method as recited in claim 1, further comprising requesting the individual engage in a fourth visualization of the traumatic event wherein the traumatic event is altered such that the individual is not injured.

10. The method as recited in claim 9, further comprising breaking from the fourth visualization and thereafter repeating the step of requesting the individual engage in the fourth visualization.

11. A method for producing a treatment record for post traumatic stress disorder which comprises an answerable record document with questions relating to:
asking an individual about a problem state; the method comprising steps of observing feedback from the individual in response to the step of asking,
identifying the individual entering the problem state and immediately thereafter breaking the problem state;
requesting the individual engage in a first visualization of an event unrelated to the problem state while the individual is in a dissociated state with respect to the first visualization;
anchoring the individual during the first visualization;
requesting the individual engage in a second visualization of a traumatic event believed to be the cause of the problem state while the individual is in a dissociated state with respect to the second visualization, the second visualization comprising a pre-traumatic still image and a post-traumatic still image;
anchoring the individual during the second visualization; and
removing the anchor after the second visualization is complete.

12. The method as recited in claim 11, further comprising establishing a rapport with the individual.

13. The method as recited in claim 11, wherein the step of anchoring comprises providing a physical anchor by physically touching the individual.

14. The method as recited in claim 11, wherein the step of anchoring comprises providing a verbal anchor by repeating a keyboard.

15. The method as recited in claim 11, wherein the step of requesting the individual engage in the second visualization of the traumatic event is performed while the individual is visualizing a pre-traumatic event still image of the individual.

16. The method as recited in claim 11, further comprising assessing whether or not the third visualization was completed without the individual experiencing distress.

17. The method as recited in claim 16, where the individual was unable to complete the third visualization without experiencing distress, the method further comprising the step of reestablishing an anchor.

18. The method as recited in claim 16, where the individual was unable to complete the third visualization without experiencing distress, the method further comprising the step of interrupting the third visualization.

19. The method as recited in claim 11, further comprising requesting the individual engage in a fourth visualization of the traumatic event wherein the traumatic event is altered such that the individual is not injured.

20. The method as recited in claim 19, further comprising breaking from the fourth visualization and thereafter repeating the step of requesting the individual engage in the fourth visualization.
